(19) United States
(12) Patent Application Publication
(10) Pub. No.: US 2016/0193817 A1
(43) Pub. Date: Jul. 7, 2016

(54) Fully Attaching Method with Jelly Adhesive

(71) Applicants: BOE Technology Group Co., Ltd., Beijing (CN); Beijing BOE Optoelectronics Technology Co., Ltd., Beijing (CN)

(72) Inventor: Wei Sun, Beijing (CN)

(21) Appl. No.: 14/753,746

(22) Filed: Jun. 29, 2015

(30) Foreign Application Priority Data
Jan. 4, 2015 (CN) 201510002302.7

(51) Int. Cl. B32B 37/12; B32B 41/00

(52) U.S. Cl. CPC B32B 37/1284; B32B 41/00; B32B 2037/1253; B32B 2307/412; B32B 2457/202; B32B 2315/08

(57) ABSTRACT

Embodiments of the present invention provides a fully attaching method, comprising: attaching a mold to a attaching surface, the mold is provided with a hollow region corresponding to a coating region of liquid optical adhesive on the attaching surface and having a shape and a size both identical with that of the coating region of liquid optical adhesive on the attaching surface; distributing the liquid optical adhesive throughout the entire hollow region of the mold; pre-curing the liquid optical adhesive to convert the liquid optical adhesive into jelly adhesive; removing excessive adhesive on a surface of the mold; removing the mold; and fully attaching the attaching surface with another attaching surface and then curing the adhesive. The method effectively avoid defects such as overflow of adhesive, short molding and air bubbles that may be generated during a fully attaching process.

This application claims priority to Chinese Patent Application No. 201510002302.7 filed on Jan. 4, 2015. The present application claims priority to and the benefit of the above-identified application and is incorporated herein in its entirety.

### TECHNICAL FILED

Embodiments of the present disclosure direct to a fully attaching method with jelly adhesive, which is performed to fully attaching a LC screen, a glass and a film and so on through liquid optical adhesive.

### BACKGROUND

According to conventional technology, when a LC screen, a piece of glass and a thin film are fully attached through liquid optical adhesive, a adhesive dispenser pin is utilized to form a pattern at one of the attaching surfaces, and defects such as overflow of adhesive, short molding and air bubbles are controlled in terms of a adhesive dispensing amount, a shape of the pattern and a location of the pattern on the attaching surface. However, due to non-uniform adhesive dispensing amount or non-uniform adhesive distribution as well as a flatness of the attaching surface and an accuracy of the apparatus, such kind of fully attaching process cannot avoid defects like overflow of adhesive, short molding and air bubbles, and etc. In order to control problems comprising excessive adhesive and the like, during subsequent processes, the manufacturers usually pre-coat a adhesive damming around the attaching surface and meanwhile controls the adhesive dispensing amount so as to avoid overflow of adhesive; however, since the adhesive damming is pre-cured and has a certain height, air existed in gaps generated during subsequent attaching process cannot be completely discharged and hence air bubbles are formed.

### SUMMARY

At least one embodiment of the present invention provides a fully attaching method with jelly adhesive, comprising: attaching a mold with a attaching surface, the mold is provided with a hollow region corresponding to a coating region of liquid optical adhesive on the attaching surface and has a shape and a size both identical with that of the coating region of the liquid optical adhesive on the attaching surface; distributing the liquid optical adhesive throughout the entire hollow region of the mold; pre-curing the liquid optical adhesive and converting the liquid optical adhesive into a jelly adhesive; removing excessive adhesive on a surface of the mold; removing the mold; and fully attaching the attaching surface with another attaching surface and then curing the adhesive.

When fully attaching a liquid crystal screen, a piece of glass, and a thin film by means of liquid optical adhesive, in the fully attaching method with jelly adhesive according to embodiments of the present invention, the liquid optical adhesive is pre-cured at a surface and is converted into solid jelly adhesive, and the coating region is defined within the attaching region by means of the hollow region of the mold; in this way, it can effectively avoid defects like overflow of adhesive, short molding and air bubbles that may be generated after a fully attaching process by taking full advantageous of the plasticity of the jelly adhesive and can ensure an uniform thickness and an uniform surface flatness of the adhesive layer by removing the excessive adhesive material with a scraper.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 schematically illustrates a first state of a fully attaching method according to an embodiment of the present invention;

FIG. 2 schematically illustrates a second state of a fully attaching method according to an embodiment of the present invention;

FIG. 3 schematically illustrates a third state of a fully attaching method according to an embodiment of the present invention;

FIG. 4 schematically illustrates a fourth state of a fully attaching method according to an embodiment of the present invention;

FIG. 5 schematically illustrates a fifth state of a fully attaching method according to an embodiment of the present invention; and

FIG. 6 schematically illustrates a sixth state of a fully attaching method according to an embodiment of the present invention.

### DETAILED DESCRIPTION OF THE PREFERRED EMBODIMENTS

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

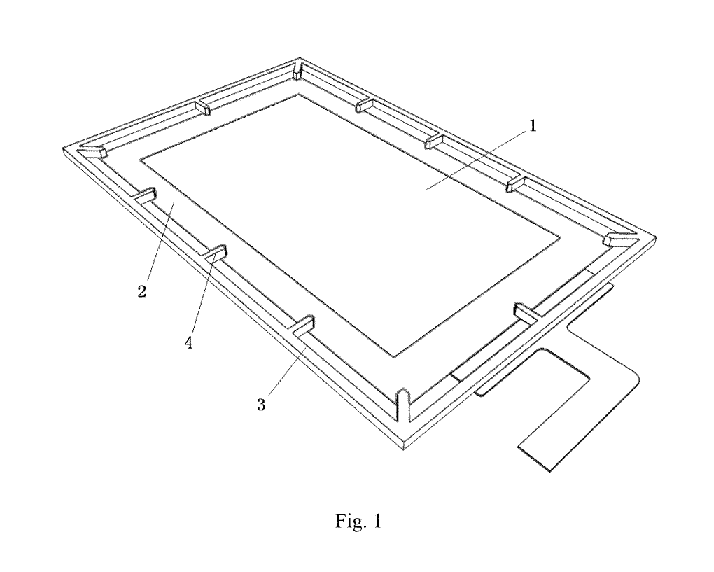

As illustrated in FIGS. 1-6, a fully attaching method according to an embodiment of the present invention comprises the following steps:

S1, as illustrated in FIG. 1, attaching a mold 2 with a attaching surface 1; the attaching surface 1 is a quadrilateral black matrix in a display region of a LC screen module; the mold 2 is provided with a hollow region formed into a rectangular shape, the hollow region of the mold 2 is disposed in a location corresponding to a coating region of liquid optical adhesive of the attaching surface 1 and has a shape and a size both identical with that of the coating region of liquid optical adhesive of the attaching surface 1.

The mold 2 can be made of a wear-resistant metal, and a mold supporting structure 3 is disposed outside of the mold 2; the mold supporting structure 3 has a hollow structure with a shape and a size both identical with that of the external side of the mold 2. An internal side of the mold supporting structure 3 is connecting to the external side of the mold 2 through a plurality of connectors 4, which, for example, are connecting to the external side of the mold 2 and to the internal side of the mold supporting structure 3 by way of laser welding.

In S1, the mold 2 and the attaching surface 2 are accurately aligned through an optical method. For example, automatically recognizing the quadrilateral black matrix in the display region of the LC screen module by a camera, and calculating a central position of the attaching surface 1 according to positions of four corners of the quadrilateral black matrix; automatically recognizing four corners of the hollow region of the mold 2 by the camera, and calculating a central position of the mold 2 according to the positions of the four corners of the hollow region; and then aligning the central position of the attaching surface 1 with the central position of the mold 2.

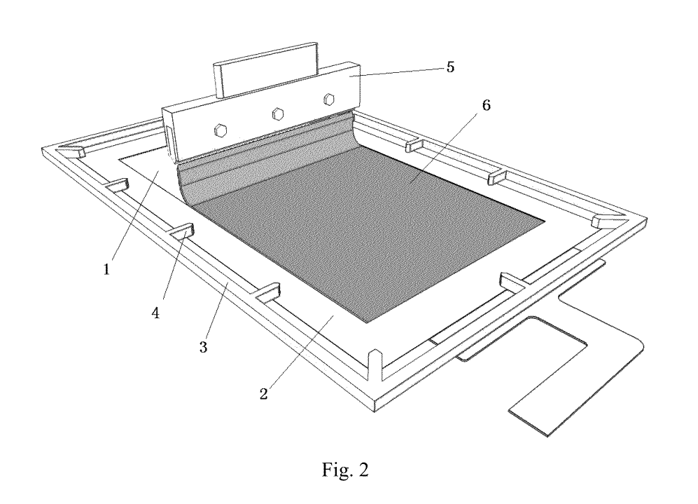

S2, as illustrated in FIG. 2, distributing liquid optical adhesive 6 on the whole surface of the attaching surface 1 and throughout the whole hollow region of the mold 2 by way of, for example, surface coating by means of a coating apparatus 5; the liquid optical adhesive 6 can be Henkel 3096 or any other types of liquid optical adhesive that can achieve required viscosity after being pre-cured.

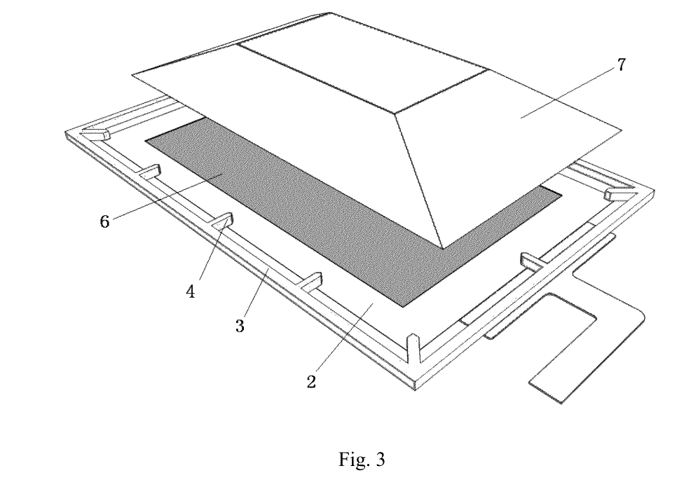

S3, as illustrated in FIG. 3, pre-curing the liquid optical adhesive 6 on the attaching surface to convert the liquid optical adhesive 6 into jelly adhesive with a viscosity of 100000 cPs˜200000 cPs under a room temperature of 25° C. by, for example, using an planar light source 7, wherein the required durance of the pre-curing is correlated with illumination intensity.

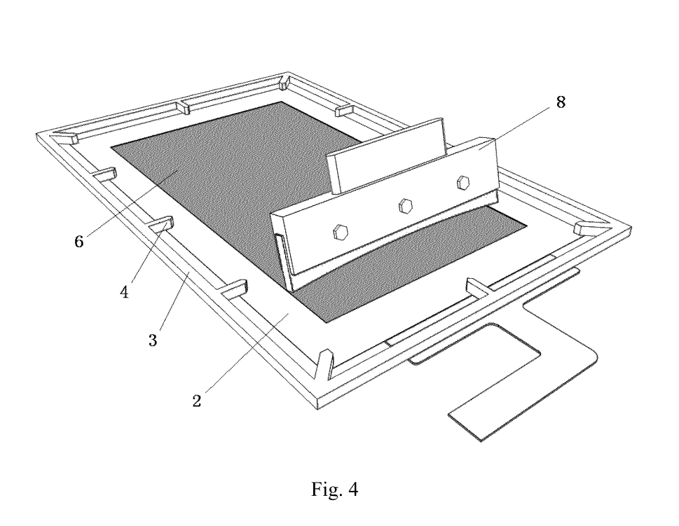

S4, as illustrated in FIG. 4, closely attaching a scraper 8 onto a surface of the mold 2 and removing excessive adhesive at an uniform velocity in horizontal direction, wherein the scraper 8 has a width larger than that of the attaching surface 1.

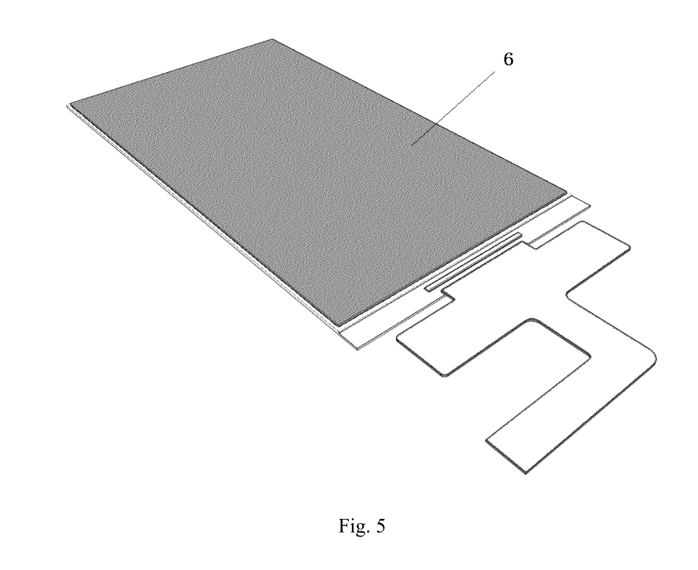

S5, as illustrated in FIG. 5, removing the mold 2, and preparing for attaching with another attaching surface 9.

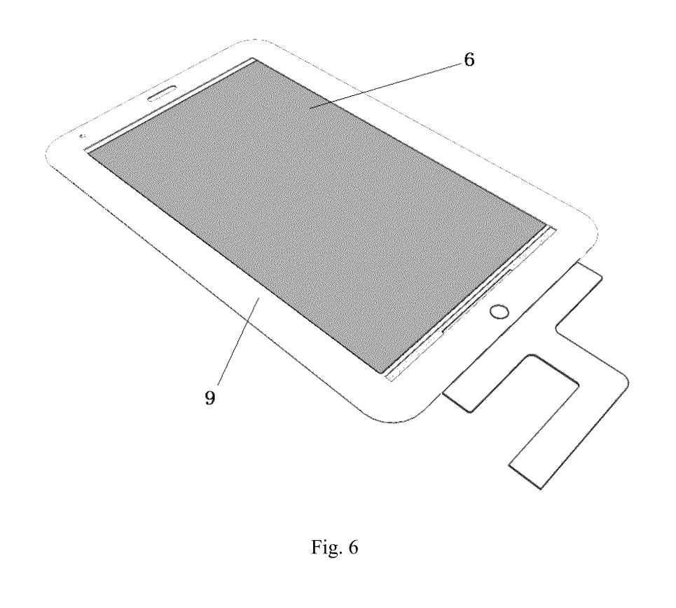

S6, as illustrated in FIG. 6, fully attaching the mold 2 with another attaching surface 9 and then curing the jelly adhesive.

During S6, fully attaching the mold 2 with another attaching surface by utilizing OCA (Optical Clear Adhesive tape) attaching solution.

The fully attaching method according to the embodiment of the present disclosure is applicable to all the fully attaching processes related to a LC screen, a piece of glass and a thin film by means of liquid optical adhesive.

When the fully attaching method with jelly adhesive according to embodiments of the present disclosure is applied in a fully attaching process performed on a LC screen, a piece of glass and a thin film by means of liquid optical adhesive, the liquid optical adhesive on the attaching surface is pre-cured to be converted into jelly adhesive, and the coating region is defined within the attaching region by means of the hollow region of the mold; in this way, it can effectively avoid defects like overflow of adhesive, short molding and air bubbles that may be generated in a fully attaching process by taking full advantageous of the plasticity of the jelly adhesive and can ensure an uniform thickness and an uniform surface flatness of the adhesive layer by removing excessive adhesive with a scraper.

Obviously, an ordinary person in the art can make various variations and modifications to the present invention without departure from the spirit and the scope of the present invention, and such variations and modifications shall fall in the scope of the present invention.

The present invention claims priority of Chinese patent application No. 201510002302.7 filed on Jan. 4, 2015, which is incorporated herein by reference in its entirely.

What is claimed is:

1. A fully attaching method, comprising:
attaching a mold to a attaching surface, the mold is provided with a hollow region corresponding to a coating region of liquid optical adhesive on the attaching surface and having a shape and a size both identical with that of the coating region of liquid optical adhesive on the attaching surface;
distributing the liquid optical adhesive throughout the entire hollow region of the mold;
pre-curing the liquid optical adhesive to convert the liquid optical adhesive into jelly adhesive;
removing excessive adhesive on a surface of the mold;
removing the mold; and
fully attaching the attaching surface with another attaching surface and then curing the adhesive.

2. The fully attaching method of claim 1, wherein distributing the liquid optical adhesive throughout the entire hollow-out area of the mold is performed by surface coating.

3. The fully attaching method of claim 1, wherein the liquid optical adhesive is pre-cured by means of a planar light source.

4. The fully attaching method of claim 1, wherein the excessive adhesive material on the surface of the mold is removed by closely attaching a scraper onto the surface of the mold.

5. The fully attaching method of claim 4, wherein the scraper has a width larger than that of the attaching surface.

6. The fully attaching method of claim 1, wherein the liquid optical adhesive after pre-cured has a viscosity of 100000 cPs˜200000 cPs.

7. The fully attaching method of claim 1, wherein the mold is made of a wear-resistant metal.

8. The fully attaching method of claim 1, wherein a mold supporting structure is disposed outside of the mold, and the mold is disposed within a hollow area of the mold supporting structure.

9. The fully attaching method of claim 8, wherein the mold is connected to the mold supporting structure.

10. The fully attaching method of claim 8, wherein the mold is welded to the mold supporting structure.

11. The fully attaching method of claim 1, wherein the attaching surface is a quadrilateral black matrix in a display region of a LC screen module, and the hollow region is formed into a shape of rectangle.

12. The fully attaching method of claim 11, wherein the mold and the bonding surface are accurately aligned by an optical method during attaching the mold with the attaching surface.

13. The fully attaching method of claim 12, wherein a central position of the attaching surface and a central position of the mold are automatically recognized by a camera, and then the central position of the attaching surface is aligned with the central position of the mold.

14. The fully attaching method of claim 1, wherein fully attaching the attaching surface with another attaching surface by using Optical Clear Adhesive tape attaching solution.

15. The fully attaching method of claim 1, wherein the liquid optical adhesive is Henkel 3096.
